(19) United States
(12) Patent Application Publication
(10) Pub. No.: US 2011/0016779 A1
(43) Pub. Date: Jan. 27, 2011

(54) GREENHOUSE FOR ENHANCED PLANT GROWTH

(75) Inventors: Ko Hermans, Nederweert (NL); Ben Slager, Rhenen (NL)

Correspondence Address: OLIFF & BERRIDGE, PLC, P.O. BOX 320850, ALEXANDRIA, VA, 22320-4850, US

(73) Assignee: GROW FOIL B.V., RHENEN (NL)

(21) Appl. No.: 12/933,222

(22) PCT Filed: Mar. 19, 2009
(86) PCT No.: PCT/EP09/53249

§ 371 Date: Sep. 17, 2010

(30) Foreign Application Priority Data
Mar. 19, 2008 (EP) 08102773.2
Oct. 16, 2008 (EP) 08166802.2

(51) Int. Cl. A01G 9/14; G02B 5/02

(52) U.S. Cl. 47/17; 359/599

(57) ABSTRACT

This application relates to a greenhouse for enhancing plant growth and a method of enhancing plant growth. A greenhouse is described that comprises transparent sheets having two main surface sides, characterised in that there is on at least one of the two main surface sides an array of geometrical optical elements and a single element of the array comprises a base and at least one other surface.

The invention pertains to a greenhouse for enhanced plant growth and a method for enhancing plant growth.

Plants use light for energy and for the spectral information it carries. Although a variety of reactions are light initiated, the two dominant reactions are photosynthesis and photomorphogenesis. In photosynthesis specialized light-absorbing pigments, which are located in the leaves, convert by a complex process light energy into chemical energy. During this reaction water and carbon dioxide are converted into high energy molecules, such as carbohydrates, and oxygen. In subsequent processes the high energy molecules are used as a building material or to power cellular processes. One of the main light absorbing pigments is chlorophyll. The activity of chlorophyll depends on the intensity of the light, but also on the wavelength distribution of the light source. The activity of chlorophyll is at its minimum between 470-600 nm, which corresponds to green light. This light is partially reflected, giving the plants their green appearance.

Photomorphogensis is a process in which light has a regulating effect on plant form, growth, development and differentiation of cells, tissues and organs. Photomorphogenesis is different from photosynthesis since the former usually requires a much lower light level and is therefore more delicate with respect to changes in the light spectrum. The main proteins responsible for the occurring reactions are phytochrome, cryptochrome, phototropins and zeaxanthin. Phytochrome is a photoreceptor which is sensitive to the red and far-red region of the visible spectrum. There are two interconvertable conformations of phytochrome with different absorption spectra referred to as Pᵣ and P_{fr}. Pᵣ absorbs red light (peak at ±660 nm) and converts into P_{fr}, while the P_{fr} isoform absorbs far red light (peak at ±730 nm) and converts into Pᵣ. P_{fr} is considered the active form of the pigment and their responses are classically defined by their red and far-red reversibility. Phytochrome is reported to influence cardian rhythms, the germination of seeds, elongation of seedlings, size, shape and number of leaves, the synthesis of chlorophylls, and the straightening of the epicotyl or hypocotyl hook of dicot seedlings. Cryptochrome, phototropins and zeaxanthin are other photoreceptors which are related to blue responses. Their influence ranges from regulating germination, elongation, photoperiodism and phototropism.

From the above it can be concluded that different processes which regulate plant growth are depended on the spectral distribution. Therefore several methods are known to improve plant growth by altering the spectral distribution.

To improve the spectral distribution of sunlight, light absorbing dyes can be used to alter the solar spectrum. These dyes can for example be dissolved in a liquid which is applied in between hollow panels which construct the roof of a greenhouse as disclosed in document DE3913552. Changing the color of the dye, and thus liquid, during the different stages of plant development can have a positive effect on plant growth and/or quality. Harmful wavelengths of UV light can be removed from the solar light spectrum by absorbing the harmful UV light with specific yellow pigments as disclosed in WO 2007/147758 A2. However, a large amount of light energy is lost due the absorption of the dyes and consequently the total light intensity, to which the plants are exposed, is reduced. Furthermore, in the case of the liquid filled hollow panels it is difficult to effectively seal the device resulting in leakage of the (toxic) liquid/dye solution.

An alternative option is to use dyes which in addition to absorbing light also re-emit a part of the absorbed light. Said dyes convert highly energetic, short wavelength light into lower energetic, longer wavelength, light, see e.g. JP57028149. Such dyes are known to those skilled in the art as photo-luminescent dyes. Said dyes can be used in a similar approach as the above described absorbing (non luminescent) dyes. However, the total light energy that reaches the plants is even further reduced as compared to a dye which only absorbs light. Several approaches are currently used which mainly vary in the wavelengths of the absorbed and/or emitted light, types and number of different dyes.

One option is converting UV light (<400 nm), which can be harmful to plants, to longer wavelength light by using organic or inorganic photo-luminescent dyes. Since said systems target to increase mainly the total light intensity, light is emitted either in the blue (JP4141025, CN1380351) or red (CN1269393, JP5227849, JP4141025, CN1385490, CN1186835, JP7170865, EP0579835 A1) which are the peak absorption wavelengths for photosynthesis. For this purpose a single dye can be used or a mixture which causes a cascading effect by which the emission of the first dye, which absorbs UV light, is absorbed by a second dye which emits it into red light. Also mixtures of more than two dyes can be utilized to convert incident radiation to wavelengths corresponding to the light bands promoting photosynthesis of plants as disclosed in FR2511840A. These systems are however inefficient due to the large difference in wavelength between absorbed and emitted light and therefore require a high level of UV. This limits the use of said systems to agricultural use in equatorial countries. Another disadvantage of said systems is the dye stability due the highly energetic nature of UV light.

Yet another option is converting green light (500-600 nm), which is less efficiently used by plants for photosynthesis, to red light (EP0077496, JP1160433) by using an organic or inorganic photo-luminescent dye. Although green light is less efficiently used by plants, complete removal will result in reduced plant growth. Therefore the concentration of dye is often low and only a part of the green light can be absorbed and consequently the increase in red light intensity in the spectrum by such dyes is low.

A third option consists of a combination of the two previously discussed approaches as disclosed in CN1307070. Said system contains a combination of UV light and green light absorbing dye and it emits blue and red light, increasing the light intensity in both photosynthetically most active regions.

All previously described methods using photo-luminescence dyes, however, loose a large amount of the emitted light by trapping of said light in the polymeric or glass matrix which comprises the dyes. This trapping is caused by the total internal reflection of the emitted light at the matrix/air interface which occurs when light reaches said interface under certain angles. As a result of this trapping, light emitted by the photo-luminescent dyes is transported to the edge of the device where it is lost. It is also possible that the trapped light is re-absorbed by the luminescent dye or the matrix and the energy is dissipated as heat. As a result of this phenomenon a large amount of light emitted by photo-luminescent molecules in a polymeric or glass matrix does not reach the plants.

In summary it can be concluded that the spectral- distribution of light effect plant growth. The spectral distribution can be improved by using photo-luminescent dyes; however a large part of the light emitted by said molecules is lost.

It is thus an object of the present invention to overcome the disadvantages of the prior art.

This object is achieved by a greenhouse for growing plants comprising transparent sheets having two main surface sides, containing a luminescent dye within the transparent sheet, characterised in that there is on at least one of the two main surface sides an array of transparent geometrical optical elements.

The term “sheet” is to be understood as a flat element with small thickness relative to its length and width. The sheet may be elastic e.g. in shape of a foil or rather rigid, e.g. a glass pane, a panel or plate made of a transparent polymeric material. The sheet as such may also be formed into a three dimensional shape for example: cylindrical, spherical, conical, cubical, or pyramidal. The sheet can thus be for example in the form of a film, glazing for greenhouse or tunnel covers, a film or filament for shading nets and screens, mulch films, non-woven or molded articles for the protection of young plants, a plate in front of an assimilation lamp or a tubular algae reactor.

The two main surface sides are those surface sides through which the majority of the light enters or leaves the sheet the greenhouse comprises. One surface side is directed towards the green houses interior, i.e. away from the light source and the other surface side is directed towards the green houses exterior, i.e. towards the light source. Apart from the two main surface sides the transparent sheet may have surfaces on its outer rim, e.g. in case of a rectangular plate four lateral surfaces.

The term “transparent” is to be understood as having an absorption coefficient (a) of less than 0.5 mm⁻¹ between 400-700 nm as determined with a spectrophotometer, preferably less than 0.2 mm⁻¹ between 400-700 nm as determined with a spectrophotometer. The absorption coefficient should be determined by measuring the absorbance (A) of the material (without luminescent dye(s) and geometrical optical structures or any other texture) over a distance I in millimeters. The absorption coefficient is equal to the absorbance divided by the distance. (α=A/I)

Contrary to light diffusing particles of random or irregular shape like e.g. chalk, the geometrical optical elements according to the invention are defined and repeating structures of angular or spherical shape, which redirect the light emitted from the luminescent dye to the plants and reduces the loss the re-emitted light.

Plants are to be considered any organism which exhibits photosynthetic abilities such as for example trees, herbs, bushes, grasses, vines, ferns, mosses, and green algae. The term greenhouse is to be understood as an at least partially enclosed environment in which plants are maintained. It encompasses thus also tunnels of plastic foil over agricultural crop or a tank for the growth of green algae.

An enhancement in plant growth can be any change in the look, taste, smell, touch or sound of at least a part of the plant. An enhanced plant growth can for example be a change in color, sweetness, bitterness, sourness, size or weight. Preferably an enhanced plant growth is an increase in biomass.

The transparent sheet having on at least one of the two main surface sides an array of geometrical optical elements should be located in between the agricultural crop within the greenhouse and the light source. The sheet can thus be located inside or outside the greenhouse.

The light source is preferably the sun. However, also artificial light sources are under the scope of the present invention. Examples of artificial light sources are lamps like a low pressure sodium lamp, a high pressure sodium lamp, a high pressure mercury lamp, xenon lamp, fluorescent lamp or a high pressure metal halide lamp, or Light Emitting Diodes (LEDs). The light source can be positioned outside or within the greenhouse.

The transparent sheet comprising an array of transparent geometrical optical elements can be used to redirect light emitted by a luminescent material contained within said sheet to further improve plant growth. Said luminescent material can be a mixture of one or more luminescent materials. The luminescent material can be electro-, chemo-, bio-, sono-, piezo-, cathode-, anode-, radio-, tribo-, crystallo-, cando-, thermo-, pyro-, mechano- or photo-luminescent. Preferably the luminescent material is a photo-luminescent dye. Photo-luminescent dyes absorb light at a certain wavelength and emit at another wavelength. The conversion may be a down conversion from a higher to a lower energetic state or an up conversion from a lower to a higher energetic state. There are inorganic or organic photo-luminescent dyes. In the framework of the present invention organic photo-luminescent dyes are preferred especially if the transparent sheet is made of a polymeric material.

An example of a typical organic photo-luminescent dye which can be used is a dye which absorbs predominantly light within the range of 200 nm-400 nm and emits predominantly between 300 nm-500 nm or absorb predominantly within the range of 400 nm-500 nm and emits predominantly between 500 nm-700 nm. An example of such a photo-luminescent dye is BASF dye violet570 and BASF rot300 or rot305. It is also possible to use a mixture of at least two organic photo-luminescent dyes e.g. a dye which absorbs predominantly light within the range of 200 nm-400 nm and emits predominantly between 300 nm-500 nm together with a dye which absorbs predominantly within the range of 400 nm-500 nm and emits predominantly between 500 nm-700 nm.

When the array of optical elements is combined with a luminescent material, the light emitted by said luminescent material is redirected in the desired direction by the array. As a consequence less light emitted by the luminescent material is lost due to internal trapping. The positive effect on plant growth caused by the luminescent material is thus enhanced by the array of optical elements.

The luminescent material within the sheet comprising the array of geometrical optical elements according to the invention should be soluble up to the desired concentration in the transparent material of which the array consists. However, the solubility of luminescent materials is in general limited thus the concentration of luminescent material in the transparent material is in general lower than desired to obtain highest efficiency in the conversion of light. The array of geometrical optical elements increases the path length of the incident light in the transparent sheet containing the luminescent material which enhances the absorption of light by the luminescent material.

An additional effect of the array of geometrical optical elements can also be that it enhances the light intensity to which the plants are exposed by redirecting light, which is reflected from the plants or their surroundings, back towards the plants. It is also possible that the array of geometrical optical elements reduces the reflection losses of the transparent sheet, which results in an increased light intensity to which the plants are exposed. In both cases plant growth is enhanced because of additional light intensity.

The transparent sheet comprises an array of geometrical optical elements which is positioned on at least one of the two main surfaces of the transparent sheet. A single geometrical optical element of such an array is characterized such that it exhibits a regular and defined structure and that it consists of a base and at least one other surface. The angle (φ) between the base and at least one other surface of which the element is comprised is preferably less than 45 degrees, more preferably less than 30 degrees and most preferably less than 20 degrees. Such an element can be a groove, a cylindrical lens, pyramid, cone, or other regular and defined structures with the restriction that the angle (φ) between the base and at least one other surface of which the element is comprised is less than 45 degrees.

In a preferred embodiment of the invention the transparent sheet comprises an array of geometrical optical elements on both main surface sides wherein the structure of the geometrical optical elements on the first main surface side is equal both in shape and location to the structure of the geometrical optical elements on the second main surface side as shown in FIG. 8b to obtain a transparent sheet with arrays of geometrical optical elements which has a constant thickness throughout the sheet and which has parallel surfaces at each location to prevent trapping of incident light and which can still redirect the light re-emitted from the luminescent material towards the plants.

In an alternative embodiment the redistribution of light can also be achieved by a combination of two optically connected transparent materials, which have different refractive indices, and have an array of geometrical optical elements facing inwards. In this specific embodiment the angle between the base and at least one other surface of which the element is comprised is more than 45 degrees, preferably more than 60 degrees and most preferably more than 70 degrees. This alternative embodiment may also have an additional set of array of geometrical optical elements on at least of on of the outside surfaces. Furthermore this alternative embodiment may also be combined with a photo-luminescent dye, preferably an organic photo-luminescent dye.

An array is to be understood as a collection or group of at least 2 elements, in this case individual geometrical optical structures arranged in rows and columns, said elements can be positioned abutting each other or separated from each other. Although such array is preferred also an at least partially random array falls under the scope of the present invention. Such a random array can for example consist of randomly distributed geometrical optical structures of different sizes, preferably hemispherical optical structures of different sizes.

The array of geometrical optical structures comprising said geometrical optical structures either arranged in rows and columns or randomly arranged may comprise only geometrical optical structures of essentially identical shape but it may also comprise geometrical optical structures of different shapes.

In a preferred embodiment the array consists of least 25 elements and more preferably of at least 100 elements per square meter. The array may consist of up to 10¹² elements per square meter in case of cones or pyramids with 1 μm² base area.

The array of geometrical optical elements is preferably made of a transparent material, which should have an absorption coefficient of less than 0.5 mm⁻¹ between 400-700 nm as determined with a spectrophotometer, more preferably less than 0.2 mm⁻¹ between 400-700 nm as determined with a spectrophotometer. This material can be inorganic however preferably polymeric. Examples of polymeric materials which can be used are: polycarbonate, polymethylmethacrylate, polypropylene, polyethylene, polyamide, polyacrylamide, polyvinylchloride or copolymers or any combinations thereof. The transparent material is preferably stabilized by UV absorbers and/or hindered amine light stabilizers. Said materials may also contain flame retarders, UV stabilizers, thermal stabilizers, anti-oxidants, plasticizers, fillers, air pockets, light scatters or titanium oxide.

The thickness of the sheet itself is preferably less than 5 cm, more preferably less than 1 cm. The thickness of the sheet and the array of geometrical optical elements is preferably less than 10 cm, more preferably less than 2 cm.

The array of optical elements can be adapted with an additional layer or coating like for example an anti-fouling coating, anti-fogging coating, anti-reflection coatings, anti-glare coatings, color reflecting/absorbing layers, infra-red filter.

The luminescent material within the sheet comprising the array of geometrical optical elements according to the invention should be soluble up to the desired concentration in the transparent material of which the array consists. In an alternative embodiment of the invention the luminescent material is present in an additional layer which is in close proximity to the transparent sheet with the array of geometrical optical elements. Preferably the additional layer containing the luminescent material is in contact with the transparent sheet comprising the array of geometrical optical elements. More preferably said layer is deposited onto the array of optical elements or vice versa.

It is another object of the present invention to provide a method for enhancing plant growth that overcomes the disadvantages of the prior art. This object is achieved by a method for enhancing plant growth in a green house, characterised in that light, preferably sunlight, reaches the plants essentially by passing through transparent sheets having two main surface sides and that there is on at least one of the two main surface sides an array of geometrical optical elements. The transparent sheet may exhibit the additional features as described above. Preferably the transparent sheet contains a luminescent material, more preferably a photo-luminescent material as previously described.

The object is also achieved by a method for enhancing plant growth in a green house, characterised in that artificial light reaches the plants essentially by passing through the sheet having two main surface sides and that there is on at least one of the two main surface sides an array of geometrical optical elements.

The invention is illustrated in more detail by means of the following figures:

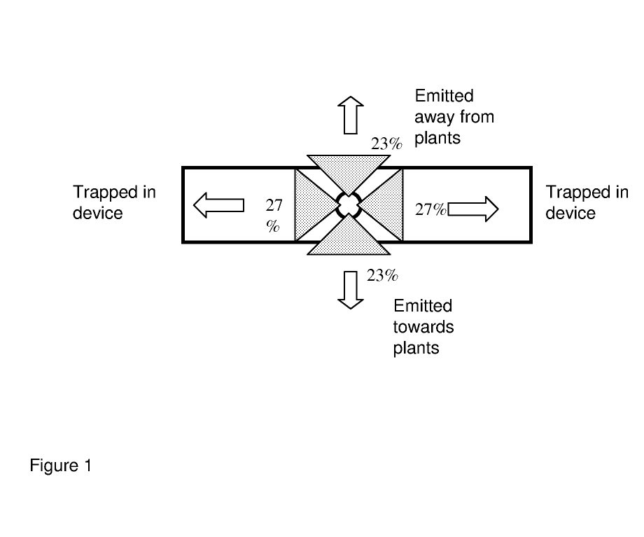

FIG. 1: Schematic representation of light emitted by a photo-luminescent dye in a non-structured plate or panel

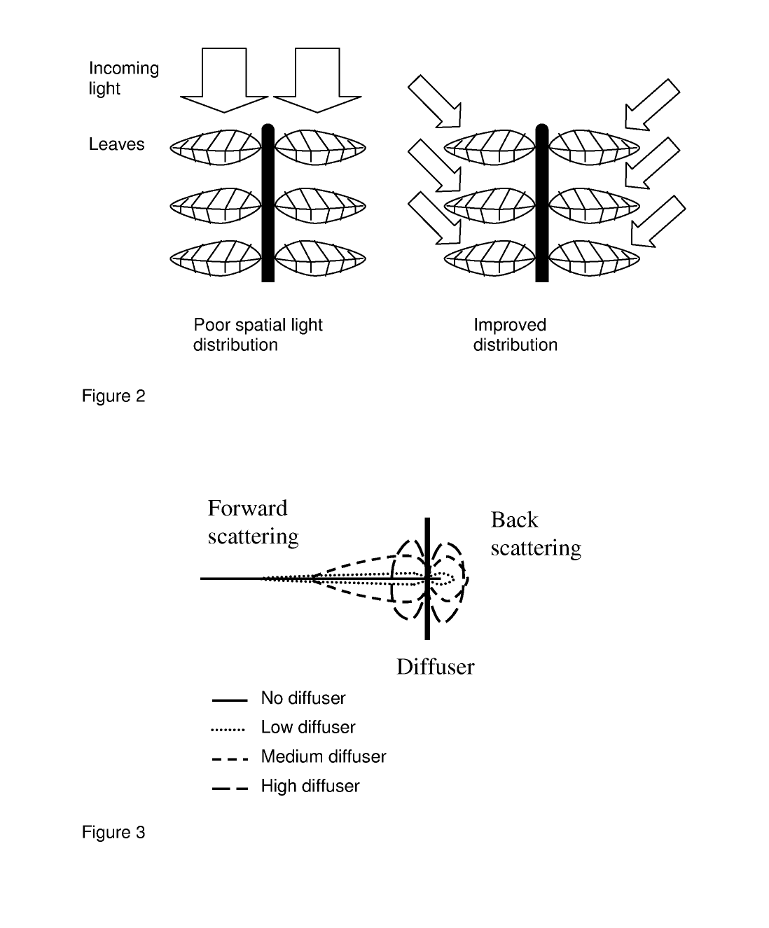

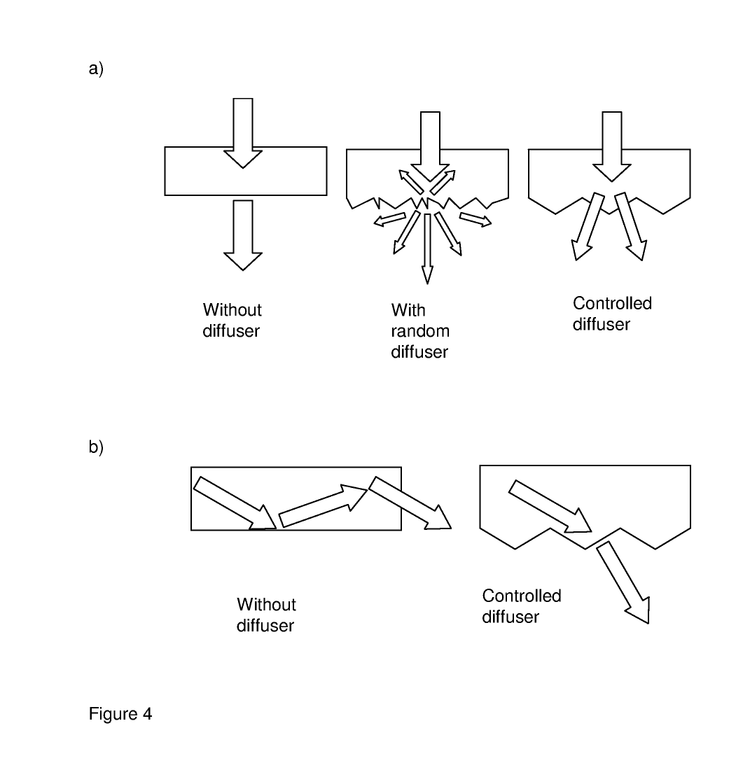

FIG. 4: d) Effect of a luminescent dye in a flat sheet according to prior art; e) Effect of a luminescent dye in a transparent sheet comprising an array of geometrical optical elements;

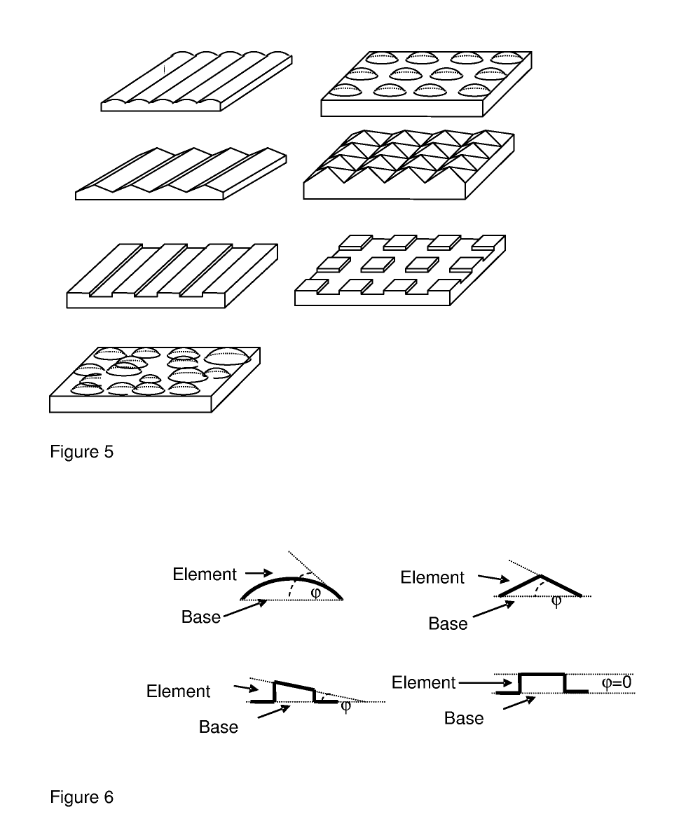

FIG. 5: Examples for the array of geometrical optical elements according to the invention

FIG. 6: Angle between base and surface of a single geometrical element

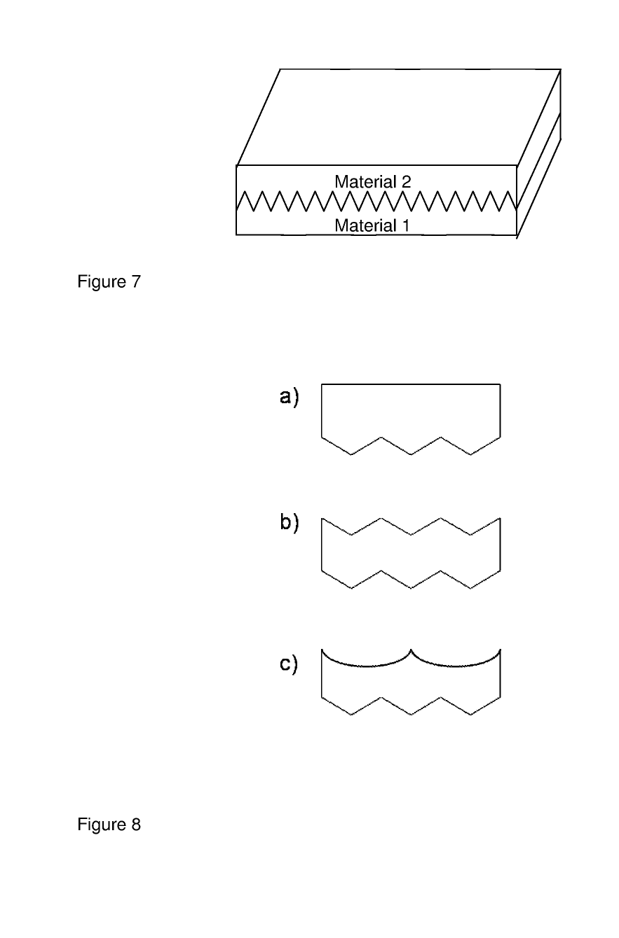

FIG. 7: Combination of two optically connected transparent materials having an array of geometrical optical elements facing inwards

FIG. 8: Examples of cross-sectional profiles of a sheet according to the invention having array(s) of geometrical optical elements on one or both main surfaces

FIG. 1 shows a schematic representation of light emitted by photoluminescent dye (schematically represented by the circle). Light is only partially emitted in the direction of the plants. A significant part of the light is trapped in the device by total internal reflection and lost.

FIG. 4 When the array of optical elements is combined with an organic photo-luminescent dye, the light emitted by said dye is redirected in the desired direction by the array and as a consequence less light emitted by the organic photo-luminescent dye is lost due to internal trapping.

FIG. 5 shows examples of the array of geometrical optical elements according to the invention.

FIG. 6 shows the angle (φ) between the base and at least one other surface of which the element is comprised. The angle (φ) is less than 45 degrees, more preferably less than 30 degrees and most preferably less than 20 degrees.

FIG. 7 shows an alternative embodiment of the transparent sheet comprising an array of geometrical optical elements. The redistribution of light in this embodiment is achieved by a combination of two optically connected transparent materials, which have different refractive indices, and have an array of geometrical optical elements facing inwards.

FIG. 8 shows a cross-sectional profile of
a) A sheet according to the invention which contains on one of the two main surfaces an array of geometrical optical elements.
b/c) A sheet according to the invention which contains on the two main surfaces arrays of geometrical optical elements.

1. Greenhouse for enhanced plant growth comprising
transparent sheets having two main surface sides, containing a luminescent dye within the transparent sheet, wherein:
there is on at least one of the two main surface sides an array of geometrical optical elements;
a single element of said array comprises a base and at least one other surface: and
an angle between the base and the at least one other surface is less than 45 degrees.

2. Greenhouse according to claim 1, wherein the transparent sheet contains a combination of two optically connected transparent materials, which have different refractive indices, and the array of geometrical optical elements faces inwards.

3. Greenhouse according to claim 2, wherein the angle between the base and at least one other surface of which a single geometrical optical element is comprised is more than 45 degrees.

4. Greenhouse according to claim 1, wherein a luminescent dye is contained within a separate layer which is in contact with the transparent sheet.

5. Greenhouse according to claim 1, wherein the luminescent dye is a mixture of different luminescent dyes.

6. Greenhouse according to claim 1, wherein the luminescent dye predominantly absorbs light between 200-400 nm and emits between 300-500 nm.

7. Greenhouse according to claim 1, wherein the luminescent dye predominantly absorbs light between 400-500 nm and emits between 500-700 nm.

8. Greenhouse according to claim 5, wherein the mixture contains a luminescent dye predominantly absorbing light between 200-400 nm and emitting between 300-500 nm and a luminescent dye predominantly absorbing light between 400-500 nm and emitting between 500-700 nm.

9. Greenhouse according to claim 1, wherein the transparent sheet is made of a polymeric material.

10. Greenhouse according to claim 1, wherein the thickness of the transparent sheet is less than 5 cm.

11. Greenhouse according to claim 1, wherein the array of transparent geometrical optical elements is adapted with one or more of the following layers or coatings: an anti-fouling coating, an anti-fogging coating, an anti-reflection coating, an anti-glare coating; color reflecting/absorbing layers, and an infra-red filter layer.

12. Transparent sheet having two main surface sides, containing a luminescent dye within the transparent sheet, wherein
there is on at least one of the two main surface sides an array of geometrical optical elements;
a single element of said array comprises a base and at least one other surface; and
the angle between the base and the at least one other surface is less than 45 degrees.

13. Transparent sheet according to claim 12, wherein the transparent sheet is placed between a light source and a plant for enhanced plant growth.

14. Method for enhancing plant growth in a green house, comprising:
passing sunlight to plants through transparent sheets containing a luminescent dye having two main surface sides; wherein
there is on at least one of the two main surface sides an array of geometrical optical elements;
a single element of said array comprises a base and at least one other surface and
the angle between the base and the at least one other surface is less than 45 degrees.

15. Method according to claim 14 wherein the transparent sheet contains a combination of two optically connected transparent materials, which have different refractive indices, and that the array of geometrical optical elements faces inwards.

16. The method of claim 14, wherein the angle between the base and at least one other surface of which a single geometrical optical element is comprised is more than 45 degrees.

17. The method of claim 14, wherein a luminescent dye is contained within a separate later which is in contact with the transparent sheet.

18. The method of claim 14, wherein the luminescent dye is a mixture of different luminescent dyes.

19. The method of claim 14, wherein the luminescent dye predominantly absorbs light between 200-400 nm and emits between 300-500 nm.

20. The method of claim 14, wherein the luminescent dye predominantly absorbs light between 400-500 nm and emits between 500-700 nm.

21. The method of claim 18, wherein the mixture contains a luminescent dye predominantly absorbing light between 200-400 nm and emitting between 300-500 nm and a luminescent dye predominantly absorbing light between 400-500 nm and emitting between 500-700 nm.

22. The method of claim 14, wherein the transparent sheet is made of a polymeric material.

23. The method of claim 14, wherein the thickness of the transparent sheet is less than 5 cm.

24. The method of claim 14, wherein the array of transparent geometrical optical elements is adapted with one or more of the following layers or coatings: an anti-fouling coating, an anti-fogging coating, an anti-reflection coating, an anti-glare coating; color reflecting/absorbing layers, and an infra-red filter layer.
